(19) United States
(12) Patent Application Publication
(10) Pub. No.: US 2020/0149254 A1
(43) Pub. Date: May 14, 2020

(54) WATER FAUCET DEVICE AND WATER FAUCET SYSTEM USING SAME

(71) Applicant: SANEI LTD., Osaka (JP)

(72) Inventor: Takao MIYAMOTO, Osaka (JP)

(73) Assignee: SANEI LTD., Osaka (JP)

(21) Appl. No.: 16/681,470

(22) Filed: Nov. 12, 2019

(30) Foreign Application Priority Data
Nov. 14, 2018 (JP) 2018-214025
Jan. 31, 2019 (JP) 2019-015466

(51) Int. Cl. E03C 1/05; G10L 15/08; G10L 15/22

(52) U.S. Cl. CPC E03C 1/057; G10L 15/08; G10L 2015/223; G10L 2015/088; G10L 15/22

(57) ABSTRACT

A water faucet device which can perform water discharge control by voice and can perform versatile water discharge control by only a designation by voice and a water faucet system using the water faucet device are provided. A water faucet device according to the invention is a water faucet device (10A) controlling a water discharge state through a network (100) by a user who talks designation contents into a voice input/output unit. The water faucet device includes an electromagnetic valve (30) to switch between an open state and a cutoff state of a flow path, a communication control unit (40) acquiring designation information based on talk information from the voice input/output unit (70) through the network (100), a detection unit (26) outputting a water discharge state of the water faucet device (10A) as a detection value, and a water discharge/stop control unit outputting, on the basis of the acquired designation information and the detection value, first control information representing whether water is discharged or stopped to the valve.

### TECHNICAL FIELD

The present invention relates to a water faucet device and a water faucet system using the same and, in particular, for example, a water faucet device coping with voice recognition and a water faucet system using the water faucet device.

### BACKGROUND ART

A conventional water faucet device which can control water discharge, water stop, and the like when a user orders a water discharge state to change by voice has been proposed.

As a combination faucet including such a voice recognition means, a combination faucet as described in Patent Literature 1 is proposed. The voice-recognition combination faucet described in Patent Literature 1 includes a combination faucet main body mixing hot water with cold water, a temperature regulation unit electrically controlling temperature regulation of the combination faucet main body, a water discharge control unit electrically controlling a water discharge amount of the combination faucet, a voice recognition unit comparing voice data input through a microphone with data pre-stored in a voice comparing memory unit to make a determination, and a combination faucet controller having a central control unit sending a control signal to the temperature regulation unit and the water discharge control unit on the basis of a determination signal from the voice recognition unit.

As another water faucet device including a voice recognition means, a water faucet as described in Patent Literature 2 is proposed. The water faucet described in Patent Literature includes a microphone converting voice into an electric signal, an amplification unit amplifying the electric signal obtained by the microphone, a voice recognition means recognizing an output from the amplification unit as a language, a water discharge state changing means changing a water discharge state, and a control unit controlling the water discharge state changing means in response to an output from the voice recognition means.

### CONVENTIONAL ART LITERATURE

### Patent Literature

Patent Literature 1: Japanese Published Unexamined Application No. 60-14677

Patent Literature 2: Japanese Published Unexamined Application No. 2000-136555

### SUMMARY OF THE INVENTION

### Problem to be Solved by the Invention

However, in the voice-recognition combination faucet described in Patent Literature 2 and the water faucet described in Patent Literature 2, when a water discharge state conflicts with information depending on a designation based on voice, no feedback may be obtained from the water faucet device itself, and the water faucet device may not react or may malfunction.

In addition, information depending on a designation based on voice for the voice-recognition combination faucet described in Patent Literature 1 or the water faucet described in Patent Literature 2 is information related to switching between a water discharge state or a water stop state or information related to temperature regulation based on a mixing ratio of hot water to cold water, and the information is hard to designate water a discharge time, a water discharge amount, or the like desired by a user.

Thus, it is a main object of the present invention to provide a water faucet device which is a water faucet device making it possible to perform water discharge control by voice and which can perform versatile water discharge control by only a designation by voice and a water faucet system using the water faucet device.

### Means for Solving the Problem

A water faucet device according to the present invention which is a water faucet device controlling a water discharge state through a network by a user who talks designation contents into a voice input/output device, and which is a water faucet device including a valve switching between an open state and a cutoff state of a flow path, a communication control means acquiring designation information based on talk information from a voice input/output unit through a network, a detection means outputting the a water discharge state of the water faucet device as a detection value, and a water discharge/stop control means outputting first control information representing whether water is discharged to the valve on the basis of the acquired designation information and the detection value.

The water faucet device according to the invention preferably includes an arithmetic processing means which calculates a water discharge condition on the basis of a detection value to output calculation information of the water discharge condition and a determination means which collates designation information and the calculation information to determine whether the calculation information satisfies contents of the designation information to output, on the basis of the determination result, second control information for controlling the valve through the water discharge/stop control means.

Furthermore, the water faucet device according to the invention preferably includes a flowmeter as the detection means.

In addition, in the water faucet device according to the present invention, calculation information includes information of an instantaneous flow rate during water discharge, and an arithmetic processing means preferably calculates a water discharge time on the basis of the calculation information including the instantaneous flow rate and the designation information including information of a designated water discharge amount.

Still furthermore, the water faucet device according to the invention, the calculation information preferably includes information of an integrated flow rate in a period from when opening to when detecting.

In the water faucet device according to the invention, a motorized valve is preferably used as a valve.

In the water faucet device according to the invention, a timing at which the detection means outputs a detection value to the arithmetic processing means is determined on the basis of the water discharge amount or the water discharge time included in the designation information.

The water faucet device according to the invention is a water faucet device which controls a water discharge state through a network by a user who talks designation contents into the voice input/output unit, the water faucet device is configured by a water faucet main body and a remote terminal connected to the network, the water faucet main body includes a valve to switch between an open state and a cutoff state of a flow path, a detection means outputting the water discharge state of the water faucet device as a detection value, and a water discharge/stop control means outputting first control information representing whether water is discharged to the valve as first control information on the basis of acquired designation information and the detection value, the remote terminal includes a communication control means acquiring designation information based on talk information from the voice input/output unit through the network, an arithmetic processing means which calculates a water discharge amount on the basis of the detection value to output the water discharge amount as calculation information, and a determination means which collates the designation information and the calculation information to determine whether the calculation information satisfies the contents of the designation information and outputs, on the basis of the determination result, the information as second control information for controlling a drive means through the water discharge/stop control means, and the remote terminal is disposed at a position where the remote terminal can be preferably connected to both the network and the water faucet main body.

The water faucet system according to the present invention is a water faucet system in which a voice input/output unit to input designation contents obtained by a user who talks and the water faucet device according to the invention are connected to each other through the network.

The water faucet system according to the present invention preferably further includes an external terminal connected through the network to check a water discharge state in the water faucet device.

Since the water faucet device according to the invention includes the detection means to detect a water discharge state, the water faucet device can detect whether water is discharged. Thus, only water discharge can be operated when the water faucet device can be designated by an operation by voice representing that water is discharged, and the water discharge can be properly controlled. On the other hand, only water stop can also be operated when the faucet device is designated by an operation by voice representing that water is stopped, and water stop can be properly controlled.

According to the water faucet device of the invention, the arithmetic processing means calculates a water discharge condition on the basis of a detection value, outputs calculation information of the water discharge condition, the determination means collate the designation information and the calculation information to determine whether the calculation information satisfies the contents of designation information and can output, on the basis of the determination result, second control information for controlling the valve through the water discharge/stop control unit.

Furthermore, according to the water faucet device of the invention, when the detection means is configured by a flowmeter, since information which is a base of an instantaneous flow rate or an integrated flow rate in a period from when opening to when detecting, proper control can be performed even though a designation is given by a water discharge amount.

According to the water faucet device of the invention, when a sampling time for outputting the detection value to the arithmetic processing means is determined on the basis of the water discharge amount or a water discharge time included in the designation information, the detection means can accurately obtain a water discharge amount desired by the user depending on the designation information.

As described above, the water faucet device according to the invention is a water faucet device which can control water discharge by voice, and high versatile discharge control can be performed by only a designation by voice.

Furthermore, according to the water discharge device of the invention, when the valve is configured by a motorized valve, water discharged by the motorized valve can be regulated in temperature, flow rate, and the like.

The water faucet device according to the invention also includes the remote terminal. When the remote terminal is disposed at a position where the remote terminal can be preferably wirelessly connected to both the network and the water faucet main body, a designation can be reliably transmitted from the voice input/output unit to the water faucet main body through the network.

### Advantages

According to the invention, the water faucet device which can control water discharge by voice and which can perform high versatile water discharge control by only a designation by voice and a water faucet system using the water faucet device can be provided.

The above object, other objects, characteristic features, and advantages of the invention will be further cleared by the following explanation of modes for carrying out the invention which will be made with reference to the drawings.

### BRIEF DESCRIPTION OF THE DRAWINGS

FIG. 1 is a schematic view showing a configuration of a water faucet system according to a first embodiment of the invention.

FIG. 2 is a perspective diagram showing a configuration of the water faucet system according to the first embodiment of the invention.

FIG. 3 is a flow chart showing an operation in a water discharge state using the water faucet system according to the first embodiment of the invention.

FIG. 4 is a flow chart showing an operation in a water stop state using the water faucet system according to the first embodiment of the invention.

FIG. 5 is a flow chart showing an operation when a predetermined water discharge amount is designated by using the water faucet system according to the first embodiment of the invention.

FIG. 6 is a schematic view showing a configuration of a water faucet system according to a second embodiment of the invention.

FIG. 7 is a schematic view showing a configuration of a water faucet system according to a third embodiment of the invention.

FIG. 8 is a schematic view showing a configuration of a water faucet system according to a fourth embodiment of the invention.

FIG. 9 is a perspective view showing a configuration of the water faucet system according to the fourth embodiment of the invention.

FIG. 10 is a schematic view showing a configuration of a water faucet system according to a fifth embodiment of the invention.

FIG. 11 shows a display in a display means of an information processing terminal of the water faucet system according to the fifth embodiment of the invention.

### EMBODIMENTS

Embodiments of the present invention will be described below with reference to the accompanying drawings. The embodiments (will be described later) are examples obtained by embodying the present invention and does not limit the technical scope of the present invention.

### 1. First Embodiment

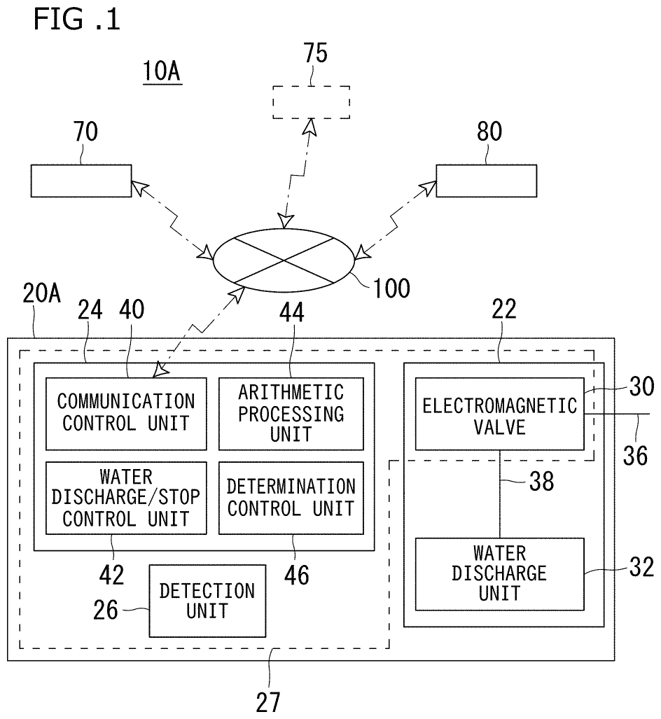

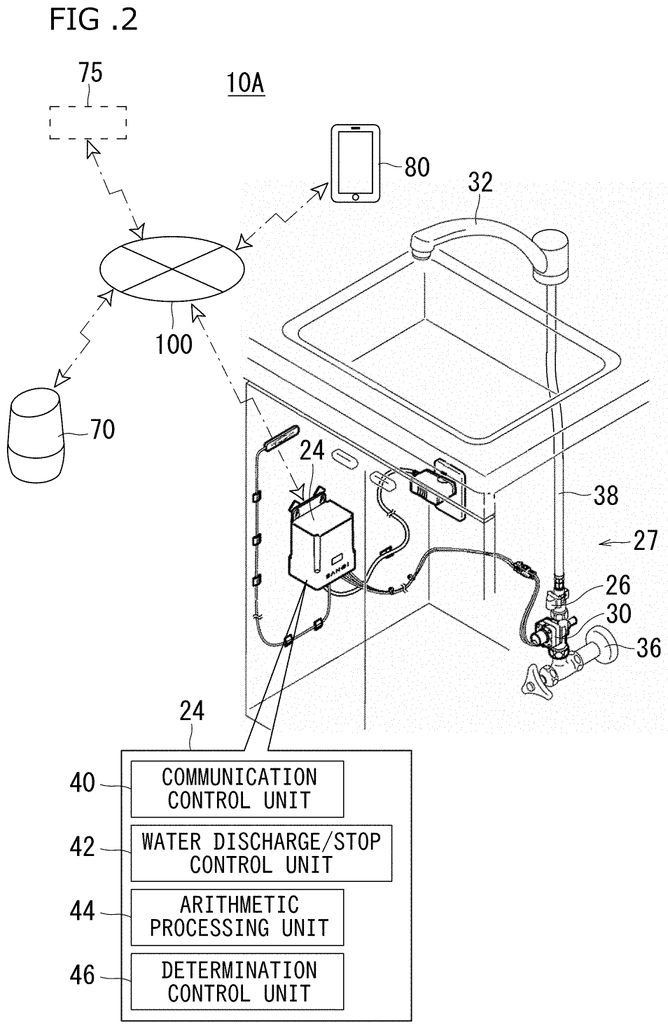

FIG. 1 is a schematic view showing a configuration of a water faucet system according to a first embodiment of the invention. FIG. 2 is a perspective view showing a configuration of the water faucet system according to the first embodiment of the invention. A water faucet device 20A included in a water faucet system 10A according to the invention, for example, is disposed on a sink in a kitchen, a washing stand, or the like. The water faucet system 10A is a system which makes a user possible to perform high versatile water discharge control by voice when the system is installed.

The water faucet system 10A is configured by a water faucet device 20A to perform water discharge control by designation information based on talk information from a voice input/output unit 70 (will be described later), the voice input/output unit 70 which receives designation contents from a user to output a water discharge state or the like from the water faucet device 20A, an information providing function unit 75 outputting designation information on the basis of talk information from the voice input/output unit 70, and an external terminal 80 to check a water discharge state, a water discharge history, and the like of the water faucet system 10A. These components are connected to each other with wires or without wires through a network 100.

The water faucet device 20A has a function which controls a water discharge state through the network 100 by a user who talks designation contents into the voice input/output unit 70.

The water faucet device 20A includes a water faucet unit 22, a control unit 24, and a detection unit 26.

The water faucet unit 22 configures a piping system to discharge water by control for determining whether water discharge is performed by the control of the control unit 24.

The water faucet unit 22 is configured by an electromagnetic valve 30 and a water discharge unit 32. The electromagnetic valve 30 is disposed to switch between an open state and a cutoff state of a flow path. A pipe 36 to supply water to the electromagnetic valve 30 is connected to the electromagnetic valve 30. The electromagnetic valve 30 is connected to the water discharge unit 32 through a pipe 38. The electromagnetic valve 30 is controlled on the basis of a control signal output from the control unit 24 (will be described below). The electromagnetic valve 30 is disposed in a water faucet hiding unit 27 under a sink in a kitchen or under a washing stand.

The water discharge unit 32 is disposed to discharge water supplied through the electromagnetic valve 30.

The control unit 24 is disposed to acquire and designation information output through the information providing function unit 75 based on talk information talked by the voice input/output unit 70 and to control the water faucet device 20A on the basis of the acquired designation information. The control unit 24 is disposed in the water faucet hiding unit 27 under a sink in a kitchen or under a washing stand.

The control unit 24 is configured by a communication control unit 40, a water discharge/stop control unit 42, an arithmetic processing unit 44, and a determination control unit 46. The control unit 24, although not shown, includes a storage means to store a water discharge situation by the water faucet device 20A as water discharge history information. The storage means stores time, day, month, and year when the user uses the water faucet device 20A, for example, information of water discharge start time and water discharge stop time.

The communication control unit 40 is disposed to acquire designation information based on talk information from the voice input/output unit through the network 100. The designation information is information generated in the information providing function unit 75 on the basis of talk information obtained by a designation of water discharge/stop designated by, for example, “discharge water”, “stop water”, or the like, a designation concretely specifying a water discharge time such as “discharge water for 30 seconds”, a designation concretely designating a water discharge amount such as “discharge 500-ml water”, or a designation such as “increase water” or “reduce water”.

The water discharge/stop control unit 42 is disposed to output first control information representing whether water is discharged to the electromagnetic valve 30 on the basis of the designation information acquired by the communication control unit 40 and a detection value output by the detection unit 26 (will be described later).

The arithmetic processing unit 44 is disposed to calculate a water discharge condition on the basis of the detection value and to output calculation information of the water discharge condition. The arithmetic processing unit 44 calculates an instantaneous flow rate and an integrated flow rate serving as the water discharge condition on the basis of the detection value detected by the detection unit 26 to create the flow rates as calculation information. In addition, when a water discharge amount is designated, a water discharge time is generated as the calculation information on the basis of the calculated instantaneous flow rate and the water discharge amount included in the designation information. As the water discharge time, for example, when the instantaneous flow rate obtained as a result of the calculation is 1 litter/min and when the water discharge amount (i.e., a water discharge amount desired by the user) is 500 ml, the water discharge time is calculated as 30 seconds. More specifically, the calculation information includes, for example, information of the calculated instantaneous flow rate, integrated flow rate, and water discharge time during water discharge. Note that, when the water discharge time and the instantaneous flow rate are to be calculated, a water discharge amount may be detected in consideration of a time (several seconds) required for stabilizing a flow rate. The arithmetic processing unit 44 has a function of counting an elapsed time from when the detection value is acquired.

The determination control unit 46 is disposed to determine whether the calculation information satisfies the contents of the designation second control information by collating the designation information acquired by the communication control unit 40 and the calculation information output by the arithmetic processing unit 44 and to output, on the basis of the determination result, the information through the water discharge/stop control means 42 as second control information for controlling the electromagnetic valve 30. Note that the determination whether the calculation information obtained by the determination control unit 46 satisfies the contents of the designation information can be made by, for example, determining whether the water discharge time calculated on the basis of the instantaneous flow rate has passed or determining whether the integrated flow rate reaches the designated water discharge amount.

The determination control unit 46 has a function of counting an elapsed time from when the calculation information is acquired.

The detection unit 26 is disposed to output a water discharge state as a detection value. As the detection unit 26, for example, a flowmeter is used. The detection unit 26 is disposed to be adjacent to the electromagnetic valve 30 on the downstream side. A detection value output from the detection unit 26 includes information representing whether the water faucet unit 22 discharges water, an instantaneous flow rate in the electromagnetic valve 30, or information which is a base of an integrated flow rate in a period from when opening to when detecting. A timing (sampling time) at which the detection unit 26 outputs a detection value to the arithmetic processing unit 44 is determined on the basis of the water discharge amount included in the designation information or the water discharge time included in the calculation information. More specifically, for example, when the water discharge time included in the designation information exceeds an N-times sampling time (for example, 1 minute×N) or when the water discharge time included in the calculation information calculated by the water discharge amount and the instantaneous flow rate exceeds an N-time sampling time (for example, 1 minute×N), the detection unit 26 outputs the detection value to the arithmetic processing unit 44 again.

The detection unit 26 is not limited to the flowmeter as long as the detection unit 26 is a sensor which can detect only whether the water faucet unit 22 discharges water.

The detection unit 26 is disposed in the water faucet hiding unit 27 under a sink in a kitchen or under a washing stand.

The voice input/output unit 70 is a loudspeaker which can use an AI- (Artificial Intelligence) assistant function corresponding to an interactive voice operation, for example, a smart speaker or an AI speaker. For example, the voice input/output unit 70 has a function of transmitting talk information serving as designation contents from the user to the information providing function unit 75, and controls the water faucet device 20A. The voice input/output unit 70 has a function which outputs information to be output from the voice output unit through the information providing function unit 75 by spontaneous talking on the basis of output information from the water faucet device 20A.

The information providing function unit 75 is disposed to converting the information into designation information to control the water faucet device 20A on the basis of the designation information talked by the user into the voice input/output unit 70 and to output the designation information. The information providing function unit 75 can be configured by, for example, IFTTT (If This Then That) and Beebotte. More specifically, the information is transmitted to the Beebotte through the IFTTT by using the talk information obtained by the voice input/output unit 70 as a trigger, and the detection information generated by the Beebotte is acquired by the communication control unit 40 in the control unit 24 of the water faucet device 20A. Note that the information providing function unit 75 is not limited to the configuration using the IFTTT and the Beetotte, and may use another similar service.

For example, the designation information is information created by the information providing function unit 75 on the basis of a talk designation of water discharge/stop designated by, for example, “discharge water”, “stop water”, or the like, a designation concretely specifying a water discharge time such as “discharge water for 30 minutes”, a designation concretely specifying a water discharge amount such as “discharge 500 ml water”, or a designation such as “increase water” or “reduce water”.

The external terminal 80 includes a communication device (not shown) which can be connected to the water faucet device 20A through the network 100, and can be configured by, for example, a mobile terminal such as a cellular phone, a smart phone, or a tablet terminal or a PC. In the water faucet system 10A according to the present invention, more preferably, the external terminal 80 includes a plurality of terminals. The external terminal 80 is connected to a storage means of the water faucet device 20A through the communication control unit 40 to make it possible to comprehend a water discharge history and a water discharge situation of the water faucet device 20A from a remote place.

Subsequently, an operation of the water faucet system 10A according to the first embodiment will be described below.

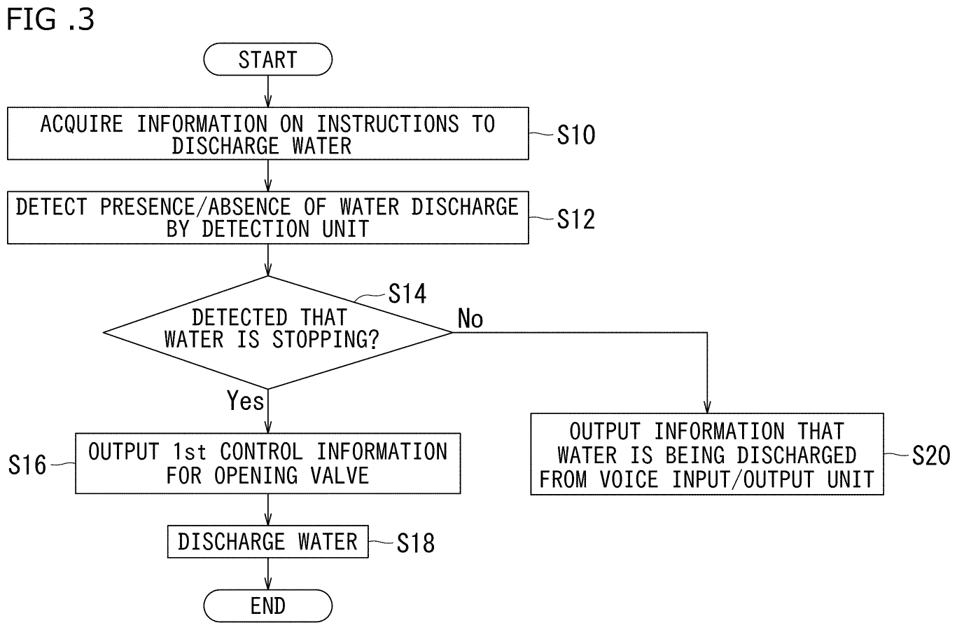

An operation of the water faucet system 10A discharging water by a user who talks to the water faucet system 10A. FIG. 3 is a flow chart showing an operation during water discharge using the water faucet system according to the first embodiment of the invention.

First, the communication control unit 40 acquires designation information representing water is discharged and created by the information providing function unit 75 on the basis of the talk information formed by the user through the voice input/output unit 70 (step S10). Subsequently, the detection unit 26 detects whether the water discharge state in the water discharge unit 22 of the water faucet device 20A is a water stop state or a water discharge state, and outputs the result to the control unit 24 as a detection value (step S12). In the control unit 24, for example, when the determination control unit 46 detects that the state is the water stop state (step S14, first control information representing that the valve opens is output to the electromagnetic valve 30 through the water discharge/stop control unit 42 (step S16). The water discharge unit 32 discharges water (step S18). On the other hand, in the control unit 24, when the determination control unit 46 detects that the state is the water discharge state (step S14), the voice input/output unit 70 spontaneously outputs information representing that water is being discharged by talking through the information providing function unit 75 (step S20).

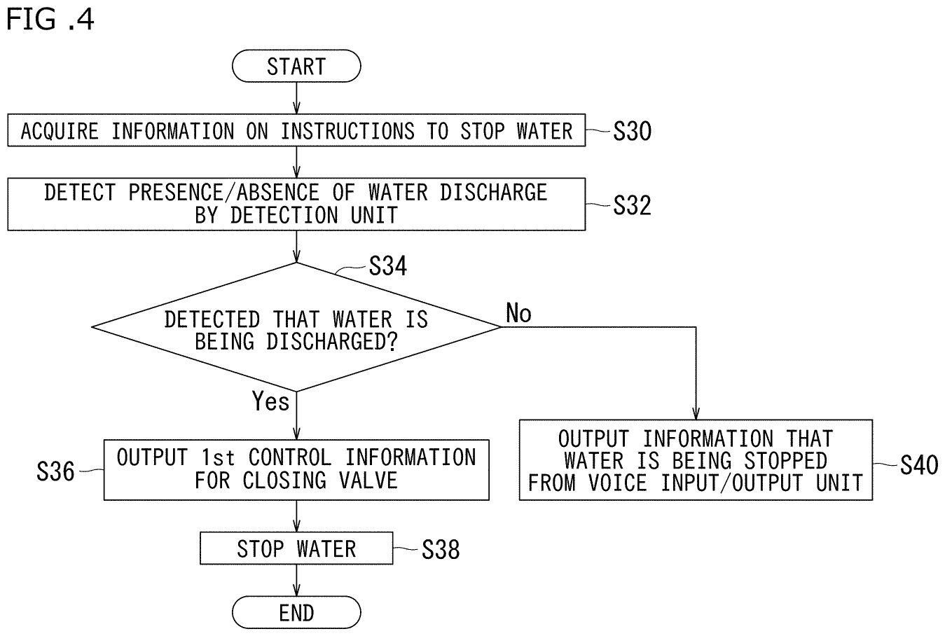

An operation of stopping water by the user who talks into the water faucet system 10A will be described below. FIG. 4 is a flow chart showing an operation performed during water stop using the water faucet system according to the first embodiment of the invention.

The communication control unit 40 acquires designation information representing that water is stopped and created by the information providing function unit 75 on the basis of talk information formed by the user through the voice input/output unit 70 (step S30). Subsequently, the detection unit 26 detects whether the water discharge state in the water discharge unit 22 of the water faucet device 20A is a water stop state or a water discharge state and outputs the result to the control unit 24 as a detection value (step S32). In the control unit 24, for example, when the determination control unit 46 detects that the state is the water discharge state (step S34), the first control information representing that the valve is closed is output to the electromagnetic valve 30 through the water discharge/stop control unit 42 (step S36). The water discharge unit 32 discharges water (step S38). On the other hand, in the control unit 24, for example, when the determination control unit 46 detects that the state is the water stop state (step S34), the voice input/output unit 70 spontaneously outputs information representing that water is being stopped by talking through the information providing function unit 75 (step S40).

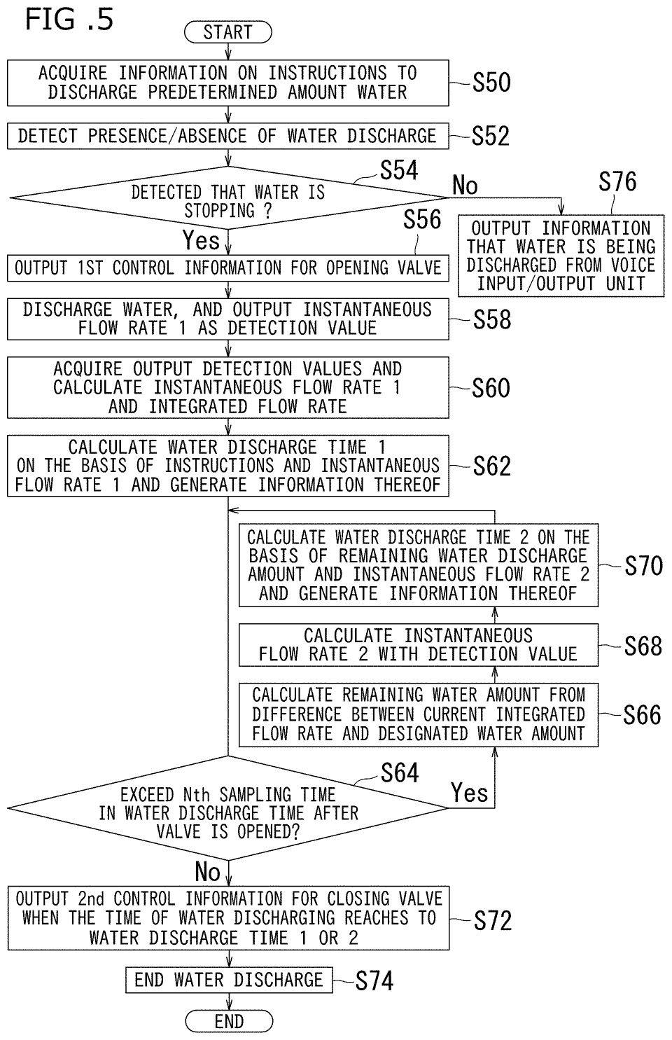

Subsequently, an operation of discharging water by a water discharge amount desired by the user who talks into the water faucet system 10A will be described below. FIG. 5 is a flow chart showing an operation performed when a predetermined water discharge amount is designated by using the water faucet system according to the first embodiment of the invention.

The communication control unit 40 acquires designation information representing that water is discharged by a water discharge amount desired by the user and created by the information providing function unit 75 on the basis of talk information formed by the user through the voice input/output unit 70 (step S50). Subsequently, the detection unit 26 detects whether a water discharge state in the water discharge unit 22 of the water faucet device 20A is a water stop state or a water discharge state, and outputs the result to the control unit 24 as a detection value (step S52). In the control unit 24, for example, when the determination control unit 46 detects that the state is the water stop state (step S54), the first control information representing that a valve is opened to the electromagnetic valve 30 (step S56). At this time, the detection unit 26 outputs an instantaneous flow rate 1 and an integrated flow rate as detection values (step S58). The arithmetic processing unit 44 acquires the output detection values to calculate the instantaneous flow rate 1 and the integrated flow rate (step S60). The arithmetic processing unit 44 calculates a water discharge time 1 on the basis of a water discharge amount described in the designation information and desired by the user and the instantaneous flow rate 1 included in the calculated calculation information to create calculation information (step S62). At this time, when a water discharge time after the valve is opened exceeds an N-times sampling time (step S64), a remaining water discharge amount is calculated on the basis of a difference between the current integrated flow rate and the designated water discharge amount (step S66). A current instantaneous flow rate 2 is calculated on the basis of the detection value (step S68). Subsequently, on the basis of the remaining water discharge amount and an instantaneous flow rate 2, a water discharge time 2 is calculated to create calculation information (step S70). The step S64 to the step S70 are repeated N times. On the other hand, when the water discharge time after the valve is opened does not exceed the N-times predetermined sampling time (step S64), when the determination control unit 46 collates the designation information and the calculation information output by the arithmetic processing unit 44 to determine whether the calculation information satisfies the contents of the designation information (for example, it is determined that the time reaches a water discharge time 1 or a water discharge time 2), on the basis of the determination result, information is output as the second control information for controlling the electromagnetic valve 30 through the water discharge/stop control means 42 (step S72). The water is stopped by the water discharge unit 32 (step S74). On the other hand, in the control unit 24, for example, when the determination control unit 46 detects that the state is the water stop state (step S54), the voice input/output unit 70 spontaneously outputs information representing that water is being discharged by talking through the information providing function unit 75 (step S76).

As shown in FIG. 5, when a predetermined water discharge amount is designated, as a method of discharging water, besides a method that calculates an instantaneous flow rate and calculates a water discharge time on the basis of the predetermined water discharge amount and the instantaneous flow rate to discharge water by the predetermined water discharge amount, a method that collates the predetermined water discharge amount and the calculated integrated flow rate to discharge water by the predetermined water discharge amount may be used.

Since the arithmetic processing unit 44 and the determination control unit 46 included in the control unit 24 of the water faucet system 10A have a function of counting an elapsed time, water can also be discharged for a water discharge time desired by the user by the user who talks into the water faucet system 10A. At this time, the determination control unit 46 collates the designation information including the information of the water discharge time acquired by the communication control unit 40 and the calculation information output by the arithmetic processing unit 44 to determine whether the water discharge time included in the designation information has passed, and, on the basis of the determination result, outputs information as second control information for controlling the electromagnetic valve 30 through the water discharge/stop control means 42.

In the water faucet system 10A, as a method of controlling a water discharge state through the network 100 by the user who talks designation contents into the voice input/output unit, a designation of an increase in water discharge amount and a designation of a decrease in water discharge amount may be operated by the user who talks during water discharge.

More specifically, when the communication control unit 40 acquires designation information representing that a water discharge amount is increased and created by the information providing function information 75 on the basis of talk information talked by the user through the voice input/output unit 70, the first control information representing that the valve of the electromagnetic valve 30 is more greatly opened is output through the water discharge/stop control unit 42. In this manner, water is discharge from the water discharge unit 32 such that the water discharge amount is more greatly increased.

On the other hand, when the communication control unit 40 acquires designation information representing that a water discharge amount is decreased and created by the information providing function information 75 on the basis of talk information talked by the user through the voice input/output unit 70, the first control information representing that the valve of the electromagnetic valve 30 is more greatly closed is output through the water discharge/stop control unit 42. In this manner, water is discharged from the water discharge unit 32 such that the water discharge amount is more greatly decreased.

Since the water faucet device 20A of the water faucet system 10A according to the first embodiment includes the detection unit 26 to detect a water discharge state in the water faucet unit 22, the water faucet device 20A can detect whether water is charged from the water faucet unit 22. Thus, only a water discharge operation can be performed when a designation is given by an operation using voice representing that water is discharged, and control can be appropriately performed. On the other hand, even though a designation is given by an operation using voice representing that water is stopped, only a water stop operation can be performed, and control can be appropriately performed.

According to the water faucet device 20A of the water faucet system 10A according to the first embodiment, the arithmetic processing unit 44 calculates a water discharge condition on the basis of a detection value, information of the water discharge condition is output as calculation information, and the determination control unit 46 collates the designation information and the calculation information to determine whether the calculation information satisfies the contents of the designation information. On the basis of the determination result, the information can be output trough the water discharge/stop control unit 40 as the second control information for controlling the electromagnetic valve 30.

Furthermore, according to the water faucet device 20A of the water faucet system 10A according to the first embodiment, when the detection unit 26 is configured by a flowmeter, information which is a base of an instantaneous flow rate or an integrated flow meter in a period from when opening to when detecting can be output as a detection value. For this reason, even though a designation is given by a water discharge amount, control can be appropriately performed.

According to the water faucet device 20A of the water faucet system 10A according to the first embodiment, a sampling time for which the detection unit 26 outputs a detection value to the arithmetic processing unit 44 is determined on the basis of a water discharge amount or a water discharge time included in the designation information. More specifically, when the water discharge time is relatively long, the accuracy of the water discharge amount may not be easily maintained. However, for example, when the water discharge time included in the designation information exceeds a predetermined sampling time or when a water discharge time calculated by the water discharge amount or the instantaneous flow rate exceeds a predetermined sampling time, the detection unit 26 may output a detection value to the arithmetic processing unit 44. Thus, a water discharge amount depending on the designation information and desired by the user can be accurately obtained.

As described above, according to the water faucet system 10A of the first embodiment, a water faucet device can make it possible to perform water discharge control by voice, and versatile water discharge control can be performed by only a designation by voice.

### 2. Second Embodiment

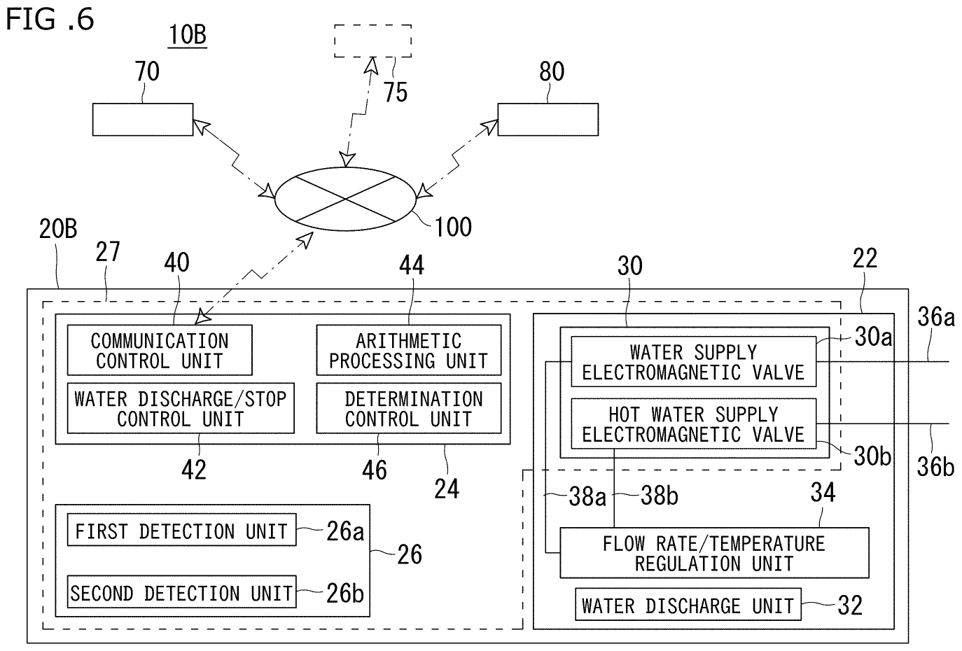

A water faucet system 10B according to a second embodiment will be described below. FIG. 6 is a schematic view showing a configuration of the water faucet system according to the second embodiment of the present invention.

A water faucet device 20B included in the water faucet system 10B according to the second embodiment includes the same configuration as that of the water faucet device 20A shown in FIG. 1 except that, in the water faucet unit 22, the electromagnetic valve 30 includes a water supply electromagnetic valve 30a and a hot water supply electromagnetic valve 30b and further includes a flow rate/temperature regulation unit 34, the pipe 36 includes a water supply pipe 36a and a hot water supply pipe 36b, the pipe 38 includes a water supply pipe 38a and a hot water supply pipe 38b, and the detection unit 26 includes a first detection unit 26a and a second detection unit 26a. Thus, the same reference numerals as in the first water faucet system 10A shown in FIG. 1 denote the same parts in the water faucet system 10B, and a description thereof will be omitted.

As shown in FIG. 6, in the water faucet system 10B, the electromagnetic valve 30 in the water faucet unit 22 includes the water supply electromagnetic valve 30a to supply water and the hot water supply electromagnetic valve 30b to supply hot water. The water supply pipe 36a is connected to the water supply electromagnetic valve 30a, and the hot water supply pipe 36b is connected to the hot water supply electromagnetic valve 30b. The water supply electromagnetic valve 30a is connected to the flow rate/temperature regulation unit 34 through the pipe 38a, and the hot water supply electromagnetic valve 30b is connected to the flow rate/temperature regulation unit 34 through the pipe 38b. The water supply electromagnetic valve 30a and the hot water supply electromagnetic valve 30b are controlled on the basis of a control signal output from the control unit 24.

The detection unit 26 includes the first detection unit 26a and the second detection unit 26b. The first detection unit 26a is disposed adjacently to the water supply electromagnetic valve 30a on the downstream side, and the second detection unit 26b is disposed adjacently to the hot water supply electromagnetic valve 30b on the downstream side. Detection values respectively detected by the first detection unit 26a and the second detection unit 26b are used to create calculation information in the arithmetic processing unit 44. The first detection unit 26a outputs a flow rate of water discharged from the water supply electromagnetic valve 30a as the detection value, and the second detection unit 26b outputs a flow rate of water discharged from the hot water supply electromagnetic valve 30b as the detection value. The detection values output from the first detection unit 26a and the second detection unit 26b include information which is a base of instantaneous flow rates in the electromagnetic valves and an integrated flow rate in a period from when opening to when detecting.

The water faucet unit 22 of the water faucet device 20B included in the water faucet system 10B further includes the flow rate/temperature regulation unit 34. The pipe 38a from the water supply electromagnetic vale 30a and the pipe 38b from the electromagnetic valve 30b are connected to the flow rate/temperature regulation unit 34. The flow rate/temperature regulation unit 34 includes a mixing valve. A lever is operated to mix a water from the water supply electromagnetic valve 30a and a hot water from the hot water supply electromagnetic valve 30b, so that a temperature and a flow rate can be manually regulated.

An operation of the water faucet system 10B according to the second embodiment will be described below.

In the water faucet system 10B according to the second embodiment, a user gives a designation by voice to make it possible to discharge not only water but also hot water. More specifically, the communication control unit 40 acquires designation information representing that water is discharged and created by the information providing function unit 75 on the basis of talk information talked by the user through the voice input/output unit 70, first control information representing each of the valves of the water supply electromagnetic valve 30a and the hot water supply electromagnetic valve 30b are opened are output through the water discharge/stop control unit 42. A temperature and a flow rate are manually regulated by using the flow rate/temperature regulation unit 34.

The water faucet system 10B may be set in advance such that hot water having a predetermined temperature or higher, for example, 42° C. or higher is not discharged. For this reason, for example, temperature sensors may be disposed on the pipes 38a, 38b, and the like.

According to the water faucet device 20B included in the water faucet system 10B according to the second embodiment, the same effect as that in the water faucet system 10A according to the first embodiment can be achieved, and the following effects can also be obtained.

More specifically, according to the water faucet device 20B included in the water faucet system 10B according to the second embodiment, since the electromagnetic valve 30 is configured by the water supply electromagnetic valve 30a and the hot water electromagnetic valve 30b, not only water but also hot water can be discharged by a designation by voice in the water faucet unit 22. A temperature and a flow rate of discharged water can be regulated by the mixing valve included in the flow rate/temperature regulation unit 34.

### 3. Third Embodiment

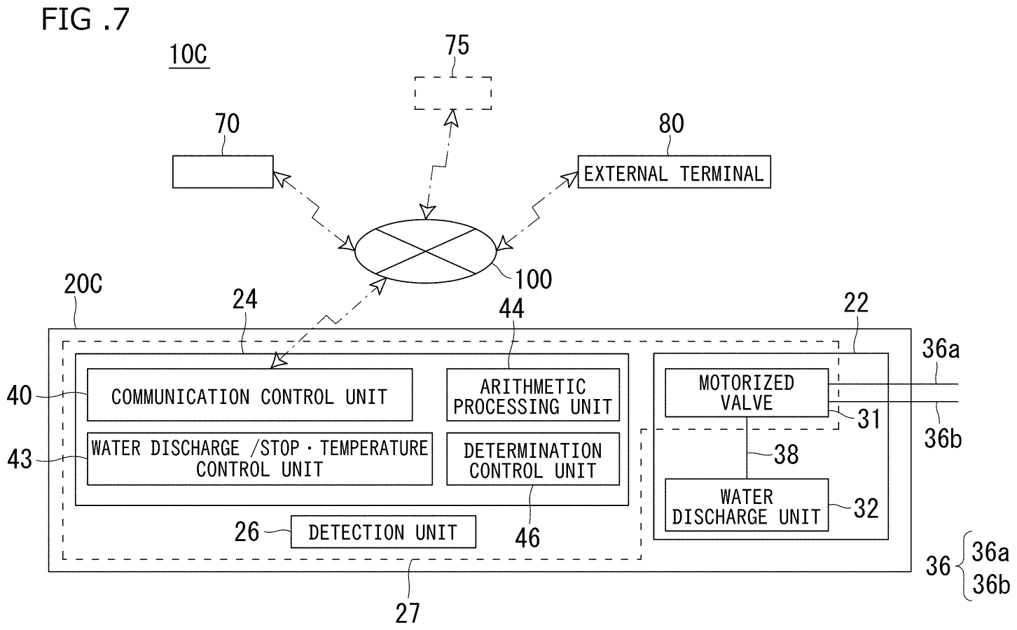

A water faucet system 10C according to a third embodiment will be described below. FIG. 7 is a schematic view showing a configuration of the water faucet system according to the third embodiment of the invention.

The water faucet device 20C included in the water faucet system 10C according to the third embodiment has the same configuration as that of the water faucet device 20A shown in FIG. 1 except that, in the water faucet unit 22, a motorized valve 31 is included in place of the electromagnetic valve 30, the pipe 36 includes the water supply pipe 36a and the hot water supply pipe 36b, and the control unit 24 includes a water discharge/stop/temperature control unit 43 in place of the water discharge/stop control unit 42. Thus, the same reference numerals in the water faucet system 10A shown in FIG. 1 denote the same parts in the water faucet system 10C, and a description thereof will be omitted.

As shown in FIG. 7, the motorized value 31 has a function which can control a water discharge amount and a water discharge temperature of water discharged from the water discharge unit 22 on the basis of control information from the water discharge/stop/temperature control unit 43 of the control unit 46. The water supply pipe 36a and the hot water supply pip 36b are connected to the motorized valve 31. The motorized valve 31 causes a drive device included in the motorized valve 31 to drive a mixing ratio of water supplied by the water supply pipe 36a and hot water supplied by the hot water supply pipe 36b and a water discharge amount, so that the water discharge temperature and the water discharge amount can be controlled.

The water discharge/stop/temperature control unit 43 has a function which outputs information as control information based on a designation representing that water is discharged or stopped and included in designation information acquired by the communication control unit 40, a water discharge time, a water discharge amount, and a water discharge temperature to the motorized valve 31.

An operation of the water faucet system 10C according to the third embodiment will be described below.

In the water faucet system 10C according to the third embodiment, a user gives a designation by voice of a user to make it possible to discharge not only water but also hot water and to make it possible to designate a temperature. More specifically, when the communication control unit 40 acquires designation information representing that water is discharged and created by the information providing function unit 75 on the basis of talk information formed by the user through voice input/output unit 70, first control information representing that the valve of the motorized valve 31 is opened by a predetermined amount is output through the water discharge/stop/temperature control unit 43. The designation information includes not only information representing water is discharged but also temperature information. The temperature information may be a specific temperature (38° C. or the like) or information given by “cold water” or “hot water”. In this manner, water discharge at a temperature desired by the user can be performed. On the other hand, when the communication control unit 40 acquires designation information representing that water stopped and created by the information providing function unit 75 on the basis of talk information formed by the user through the voice input/output unit 70, first control information representing that the valve of the motorized valve 31 is closed is output through the water discharge/stop/temperature control unit 43. In this manner, the user can stop water.

According to the water faucet device 20C included in the water faucet system 10C according to the third embodiment, the same effect as that in the water faucet system 10A according to the first embodiment can be achieved, and the following effects are also achieved.

More specifically, since the water faucet device 20C included in the water faucet system 10C according to the third embodiment is configured by the motorized valve 31, the water faucet device 20C can be operated by a designation by voice such that a flow rate of discharged water and a water discharge temperature are regulated.

### 4. Fourth Embodiment

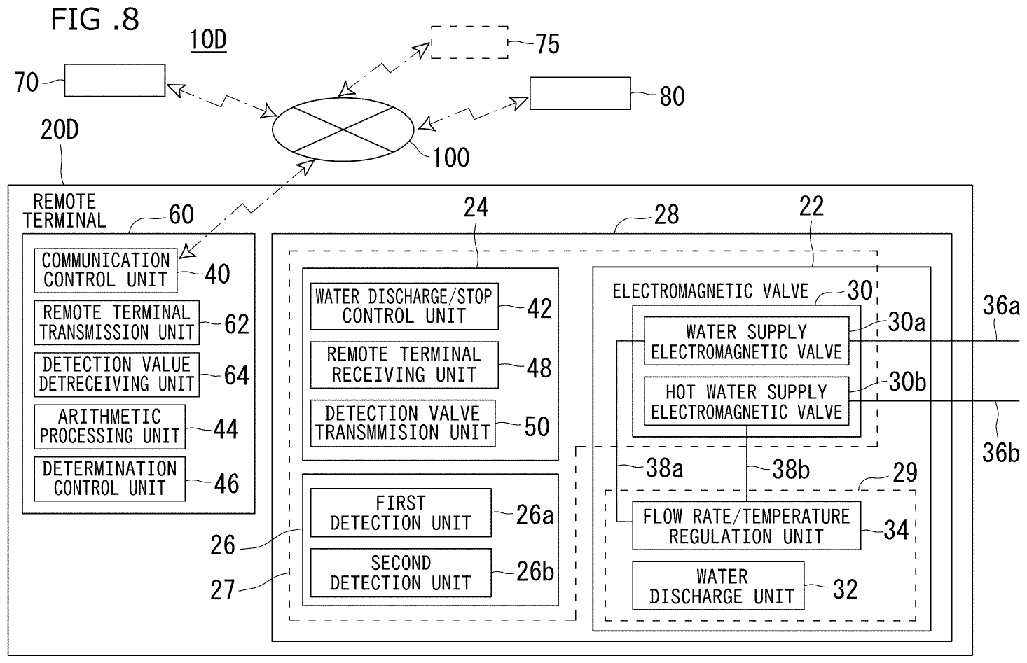

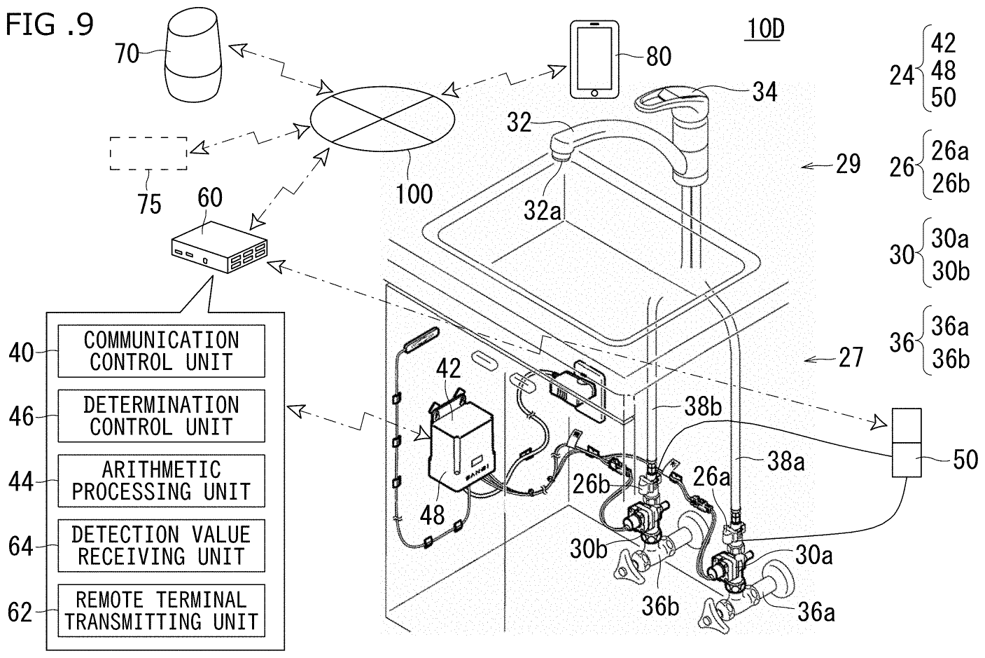

A water faucet system 10D according to a fourth embodiment will be described below. FIG. 8 is a schematic view showing a configuration of the water faucet system according to the fourth embodiment of the invention. FIG. 9 is a perspective view showing a configuration of the water faucet system according to the fourth embodiment of the invention.

As shown in FIG. 8 and FIG. 9, when a water faucet device 20D included in the water faucet system 10D according to the fourth embodiment is compared with the water faucet device 20A configuring the water faucet system 10A according to the first embodiment, the water faucet device 20D further includes a water faucet main body 28 and a remote terminal 60.

The water faucet main body 28 includes the water faucet unit 22, the control unit 24, and the detection unit 26.

The water faucet unit 22 is configured by the electromagnetic valve 30, the water discharge unit 32, and the flow rate/temperature regulation unit 34. The electromagnetic valve 30 includes the water supply electromagnetic valve 30a for supplying water and the hot water supply electromagnetic valve 30b for supplying hot water. The water supply pipe 36a is connected to the water supply electromagnetic valve 30a, and the hot water supply pipe 36b is connected to the hot water electromagnetic valve 30b. The water supply electromagnetic valve 30a is connected to the flow rate/temperature regulation unit 34 through the pipe 38a, and the hot water electromagnetic valve 30b is connected to the flow rate/temperature regulation unit 34 through the pipe 38b. The water supply electromagnetic valve 30a and the hot water electromagnetic valve 30b are controlled on the basis of a control signal output from the control unit 24. The electromagnetic valve 30 (the water supply electromagnetic valve 30a and the hot water electromagnetic valve 30b) are disposed in the water faucet hiding unit 27 under a sink in a kitchen or under a washing stand.

In the water discharge unit 32, a constant flow rate valve 32a is disposed. The constant flow rate valve 32a is disposed on a downstream side on which hot water and water are mixed with each other. As the constant flow rate valve 32a, for example, an aerator with a constant flow rate valve function can be used.

The control unit 24 is configured by the water discharge/stop control unit 42, a water discharge/stop control unit 42, a remote terminal receiving unit 48, and a detection value transmitting unit 50. The remote terminal receiving unit 48 is disposed to receive a control signal transmitted by a remote terminal transmitting unit 62 (will be described below) included in the remote terminal 60. The detection value transmitting unit 50 is disposed to transmit a detection value acquired from the detection unit 26 to a detection value receiving unit 64 (will be described later) included in the remote terminal 60. The control unit 24 is disposed in the water faucet hiding unit 27 under a sink in a kitchen or under a washing stand. In this manner, since the control unit 24 is disposed in the water faucet hiding unit 27, a direct wireless connection to the network 100 may be difficult.

The detection unit 26 includes a first detection unit 26a and a second detection unit 26b. The first detection unit 26a is disposed adjacently to the water supply electromagnetic valve 30a on a downstream side, and the second detection unit 26b is disposed adjacently to the hot water supply electromagnetic valve 30b on a downstream side. Detection values detected by the first detection unit 26a and the second detection unit 26b are used to create calculation information in the arithmetic processing unit 44. The first detection unit 26a outputs a flow rate of water discharged from the water supply electromagnetic valve 30a as a detection value, and the second detection unit 26b outputs a flow rate of water discharged from the hot water electromagnetic valve 30b as a detection value. The detection values output by the first detection unit 26a and the second detection unit 26b include information which is a base of instantaneous flow rates in the electromagnetic valves and an integrated flow rate in a period from when opening to when detecting. The detection unit 26 is disposed in the water faucet hiding unit 27 under a sink in a kitchen or under a washing stand.

The remote terminal 60 is disposed at a position where the remote terminal 60 can be preferably connected to both the network 100 and the water faucet main body 28. More specifically, for example, the remote terminal 60 is disposed in an open unit 29 on the upper part of a sink in a kitchen or on the upper part of a washing stand. The remote terminal 60 is configured by the communication control unit 40, the arithmetic processing unit 44, the determination control unit 46, the remote terminal transmitting unit 62, and the detection value receiving unit 64. The remote terminal transmitting unit 62 is disposed to transmit designation information acquired by the communication control unit 40 and information of a determination result obtained by the determination control unit 46. The detection value receiving unit 64 is disposed to receive a detection value transmitted by the detection value transmitting unit 50 of the control unit 24 and to output the detection value to the arithmetic processing unit 44.

An operation of the water faucet system 10D according to the fourth embodiment will be described below.

In the water faucet system 10D according to the fourth embodiment, when a user gives a designation by talking, not only water but also hot water can be discharged. More specifically, when the communication control unit 40 acquires designation information representing that water is discharged and created by the information providing function unit 75 on the basis of talk information formed by the user through the voice input/output unit 70, first control information representing that the valves of the water supply electromagnetic valve 30a and the hot water supply electromagnetic valve 30b are opened is output through the water discharge/stop control unit 42. A temperature and a flow rate can be manually regulated by using the flow rate/temperature regulation unit 34. At this time, since the network 100 and the water faucet device 20D included in the water faucet system 10D are connected to each other through the remote terminal 60 disposed in the open unit 29 on the upper part of the sink in the kitchen or on the upper part of the washing stand, stable communication can be established, and water discharge/stop or the like of the water faucet device 20D by the water faucet system 10D on the basis of talk information of the user can be stably controlled.

According to the water faucet device 20D included in the water faucet system 10D according to the fourth embodiment, the same effect as that in the water faucet system 10A according to the first embodiment can be achieved, and the following effects can also be achieved.

More specifically, according to the water faucet device 20D included in the water faucet system 10D according to the fourth embodiment, since the water faucet device 20D includes the remote terminal 60, the remote terminal 60 is disposed at a position where the remote terminal 60 can be preferably wirelessly connected to both the network 100 and the water faucet main body 28 to make it possible to reliably transmit a designation from the voice input/output unit 70 to the control unit 44 of the water faucet main body 28 through the network 100.

### 5. Fifth Embodiment

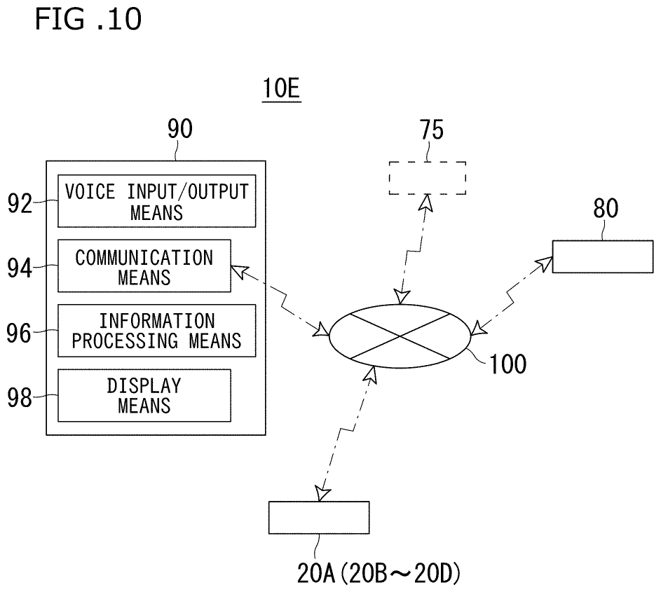

A water faucet system 10E according to a fifth embodiment will be described below. FIG. 10 is a schematic view showing a configuration of the water faucet system according to the fifth embodiment of the invention.

As shown in FIG. 10, the water faucet system 10E according to the fifth embodiment is compared with the water faucet system 10A according to the first embodiment to the water faucet system 10D according to the fourth embodiment, the water faucet system 10E is different from the water faucet systems 10A to 10D in that an information processing terminal 90 is included in place of the voice input/output unit 70.

The information processing terminal 90 includes a voice input/output means 92, a communication means 94, an information processing means 96, and a display means 98. The information processing terminal 90, for example, is configured by an information processing terminal such as a smart phone or a tablet terminal. The information processing terminal 90 is preferably configured by a terminal having a size to be held by one hand.

The voice input/output means 92 has a function which acquires talk information formed by talking by the user to output the talk information to the information processing means 96. The voice input/output means 92 has a function which, on the basis of output information from the water faucet device 20A (to 20D), spontaneously outputs information to be output by the information processing terminal 90 through the information providing function unit 75 by talking. The voice input/output means 92 is configured by, for example, a loudspeaker.

The communication means 94 is connected to the network 100 and has a function to communicate with the water faucet device 20A (to 20D), the information providing function unit 75, and the like through the network 100. The communication means 94, for example, can use communication techniques such as Bluetooth (trademark), Zigbee (trademark), and WiFi (trademark) which can establish communication with an ultra-low power. In addition, the communication means 94 is configured to be able to use, as a communication system with the network 100, for example, in addition to a third generation (3G: 3rd. Generation) mobile communication system, an LTE (Long Term Evolution) system, a 4G system, a 5G system, an FDMA system, a TDMA system, a CDMA system, and a W-CDMA system, a PHS (Personal Handy phone System) system and the like. In this manner, the water faucet device 20A (to 20D) can be remotely operated by using the information processing terminal 90 having the communication means 94.

The information processing means 96 has a function for processing talk information acquired such that software having an AI assistant function corresponding to an interactive voice operation can be incorporated (installed). The information processing means 96 has a function for transmitting talk information by the user acquired by the voice input/output means 92 to the information providing function unit 75 through the communication means 94. The software having the AI assistant function need not only be updated for the information processing means 96 included in the information processing terminal 90, and software for controlling the water faucet device 20A (to 20D) need not be updated.

The display means 98 is disposed to display an operation state obtained by the software having the AI assistant function incorporated in the information processing means 96. The display means 98 is configured by a display or the like configured by a device which can display the operation state, for example, a liquid crystal, an organic EL, or the like.

In this case, since an operation of the water faucet system 10E according to the fifth embodiment is the same as that of the water faucet system 10A according to the first embodiment to the water faucet system 10D according to the fourth embodiment except that talk information by the user is acquired by the information processing terminal 90 in place of the voice input/output unit 70, a description thereof will be omitted.

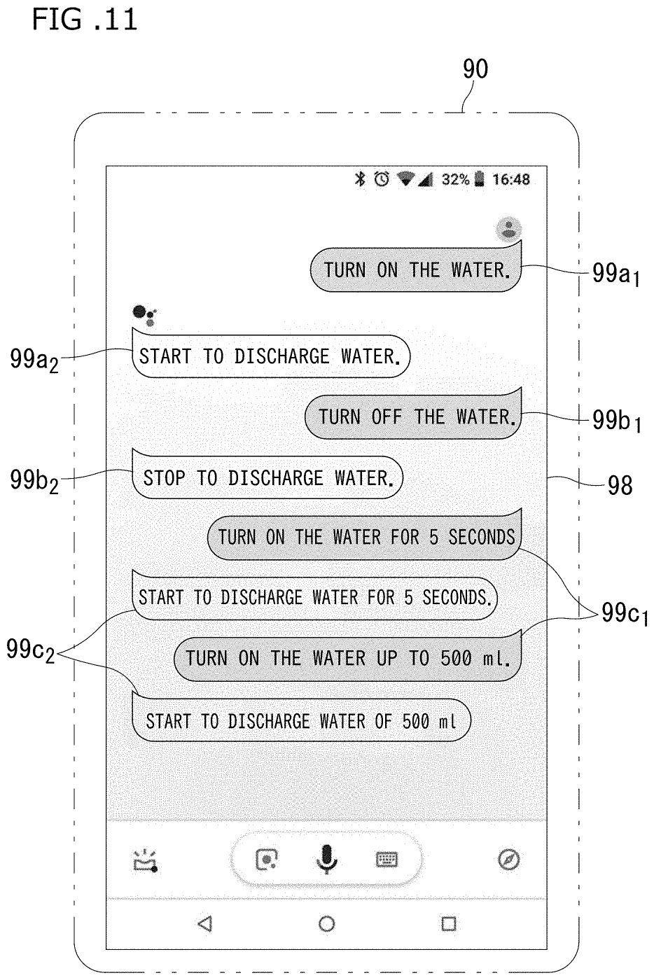

As shown in FIG. 11, in an operation of the water faucet system 10E according to the fifth embodiment, the talk information by the user is acquired by the software having the AI assistant function corresponding to the interactive voice operation incorporated in the information processing means 96, and is displayed on the display means 98 each time the talk information is processed.

More specifically, when the talk information from the user is a water discharge designation, a character string (“discharge water”) 99a1 is displayed on the display means 98, on the basis of the flow chart shown in FIG. 3, an operation when water is discharged is executed, and, subsequently, a character string (“water will be discharged”) 99a2 of information representing that water is being discharged from the water faucet device 20A is displayed. On the other hand, when talk information from the user is a water stop designation, a character string (“stop water”) 99b1 of talk information for designating water stop is displayed on the display means 98, and, on the basis of the flow chart shown in FIG. 4, an operation when water is stopped is executed. Subsequently, a character string (“water will be stopped”) 99b2 of information representing that water is being stopped from the water faucet device 20A is displayed.

When talk information from the user is a water discharge designation of water discharged by a water discharge amount desired by the user, a character string (“discharge water for 5 seconds” or “discharge 500 ml water”) 99c1 of talk information for designating the water discharge amount desired by the user is displayed on the display means 98, on the basis of the flow chart shown in FIG. 5, an operation of discharging water by the predetermined water discharge amount. Subsequently, a character string (“water will be discharged for 5 seconds” or “500 ml water will be discharged”) 99c2 of information representing that water is being discharged by the water discharge amount desired by the user from the water faucet device 20A is displayed.

According to the water faucet system 10E according to the fifth embodiment, the same effect as that in the water faucet system 10A according to the first embodiment to the water faucet system 10D according to the fourth embodiment can be achieved, and the following effects are achieved.

More specifically, according to the water faucet system 10E of the fifth embodiment, the user need not move to a place where the voice input/output unit 70 is installed to give designation for discharging/stopping water and talk, and a designation for discharging/stopping water can be given by using the information processing terminal 90 held by one hand.

According to the water faucet system 10E according to the fifth embodiment, when the communication means 94 is configured to be able to use, as a communication system with the network 100, for example, in addition to a third generation (3G: 3rd. Generation) mobile communication system, an LTE (Long Term Evolution) system, a 4G system, a 5G system, an FDMA system, a TDMA system, a CDMA system, and a W-CDMA system, a PHS (Personal Handy phone System) system and the like, the water faucet device 20A to (to 20D) can be operated by using the information processing terminal 90 including the communication means 94 from a distant place such as a place where the user has gone. In this manner, for example, an operation for supplying drinking water for pets can be performed from a place wherein the user has gone.

As described above, although the embodiments of the present invention are disclosed in the above description, the present invention is not limited to the embodiments.

More specifically, various changes of the embodiments described above can be effected on mechanisms, shapes, materials, quantities, positions, arrangements, and the like without departing from the technical spirit and scope of the present invention, and the various changes are included in the present invention.

For example, in the water faucet device 20A of the water faucet system 10A according to the first embodiment, the control unit 24 does not always include the arithmetic processing unit 44 and the determination control unit 46.

In the water faucet device 20D of the water faucet system 10D according to the fourth embodiment, although the electromagnetic valve 30 is configured by the water supply electromagnetic valve 30a and the hot water supply electromagnetic valve 30b, the electromagnetic valve 30 is limited to the configuration and may be configured by only one electromagnetic valve 30 or may be configured by the motorized valve 31.

### INDUSTRIAL APPLICABILITY

The water faucet device according to the invention and the water faucet system using the water faucet device is, for example, a water faucet device disposed in a sink or a counter in a kitchen, a washing stand, or the like. When a user talks designation contents into the voice input/output unit, the water faucet device and the water faucet system can be preferably used as a water faucet device controlling a water discharge state through a network and a water faucet system using the water faucet device.

### REFERENCE NUMERALS

10A, 10B, 10C, 10D 10E water faucet system
20A, 20B, 20C, 20D water faucet device
22 water faucet unit
24 control unit
26 detection unit
26a first detection unit
26b second detection unit
27 water faucet hiding unit
28 water faucet main body
29 open unit
30 electromagnetic valve
30a water supply electromagnetic valve
30b hot water supply electromagnetic valve
31 motorized valve
32 water discharge unit
32a constant flow rate valve
34 flow rate/temperature regulation unit
36 pipe
36a water supply pipe
36b hot water supply pipe
40 communication control unit
42 water discharge/stop control unit
43 water discharge/stop/temperature control unit
44 arithmetic processing unit
46 determination control unit
48 remote terminal receiving unit
50 detection value transmission unit
60 remote terminal
62 remote terminal transmission unit
64 detection value receiving unit
70 voice input/output unit
75 information providing function unit
80 external terminal
90 information processing terminal
92 voice input/output means
94 communication means
96 information processing means
98 display means
99a1 character string of talk information for designating water discharge
99a2 character string of information representing that water is being discharged
99b1 character string of talk information for designating water stop
99b2 character string of information representing that water is being stopped
99c1 character string of talk information for designating water discharge amount desired by user
99c2 character string of information representing that water is being discharged by water discharge amount desired by user
100 network

1. A water faucet device which controls a water discharge state through a network by a user who talks designation contents into a voice input/output unit, comprising:
a valve to switch between an open state and a cutoff state of a flow path;
a communication control means acquiring designation information based on talk information from the voice input/output unit through the network;
a detection means outputting a water discharge state of the water faucet device as a detection value; and
a water discharge/stop control means outputting, on the basis of the acquired designation information and the detection value, first control information representing whether water is discharged or stopped to the valve.

2. The water faucet device according to claim 1, comprising:
an arithmetic processing means calculating a water discharge condition on the basis of the detection value to output information of the water discharge condition as calculation information; and
a determination means which collates the designation information and the calculation information to determine whether the calculation information satisfies contents of the designation information and outputs, on the basis of the determination result, the information as second control information for controlling the valve through the water discharge/stop control means.

3. The water faucet device according to claim 1, wherein the detection means is a flowmeter.

4. The water faucet device according to claim 2, wherein
the calculation information includes information of an instantaneous flow rate during water discharging, and
the arithmetic processing means
calculates a water discharge time on the basis of the calculation information including the instantaneous flow rate and the designation information including the information of the designated water discharge amount.

5. The water faucet device according to claim 2, wherein the calculation information includes information of an integrated flow rate in a period from when opening to when detecting.

6. The water faucet device according to claim 1, wherein the valve is a motorized valve.

7. The water faucet device according to claim 2, wherein a sampling time to output the detection value to the arithmetic processing means by the detection means is determined on the basis of the water discharge amount or the water discharge time included in the designation information or the calculated water discharge time.

8. A water faucet device which controls a water discharge state through a network by a user who talks detection contents into the voice input/output unit, wherein
the water faucet device is configured by
a water faucet main body and a remote terminal connected to the network,
the water faucet main body includes
a valve to switch an open state and a cutoff state of a flow path,
a detection means outputting a water discharge state of the water faucet device as a detection value, and
a water discharge/stop control means, on the basis of the acquired designation information and the detection value, outputting first control information representing whether water is discharged or stopped to the valve,
the remote terminal includes
a communication control means acquiring designation information based on talk information from the voice input/output unit through the network,
an arithmetic processing means calculating a water discharge amount on the basis of the detection value to output the information as calculation information, and
a determination means which collates the designation information and the calculation information to determine whether the calculation information satisfies contents of the designation information and outputs, on the basis of the detection result, the information as second control information for controlling the driving means through the water discharge/stop control means, and
the remote terminal is disposed at a position where the remote terminal can be preferably connected to both the network and the water faucet main body.

9. A water faucet system wherein
a voice input/output unit to input designation contents obtained by talking by a user and
the water faucet device according to claim 1 are connected to each other through a network.

10. The water faucet system according to claim 9, wherein
the voice input/output unit is configured by an information processing terminal held by one hand,
the information processing terminal includes a voice input/output means to acquire talk information obtained by talking by a user, a communication means to connect the information processing terminal to the network, and an information processing means in which an AI assistant function corresponding to an interactive voice operation is usably incorporated and which has a function for processing the acquired talk information and transmitting the information through the communication means.

11. The water faucet system according to claim 9, further comprising an external terminal connected through the network to check a water discharge state in the water faucet device.

12. The water faucet device according to claim 2, wherein the detection means is a flowmeter.

13. The water faucet device according to claim 2, wherein the valve is a motorized valve.

14. A water faucet system wherein
a voice input/output unit to input designation contents obtained by talking by a user and
the water faucet device according to claim 2 are connected to each other through a network.

15. The water faucet system according to claim 14, wherein
the voice input/output unit is configured by an information processing terminal held by one hand,
the information processing terminal includes a voice input/output means to acquire talk information obtained by talking by a user, a communication means to connect the information processing terminal to the network, and an information processing means in which an AI assistant function corresponding to an interactive voice operation is usably incorporated and which has a function for processing the acquired talk information and transmitting the information through the communication means.

16. The water faucet system according to claim 14, further comprising an external terminal connected through the network to check a water discharge state in the water faucet device.
